(19) United States
(12) Patent Application Publication
(10) Pub. No.: US 2024/0227071 A9
(43) Pub. Date: Jul. 11, 2024

(54) LASER-PROCESSING APPARATUS, METHODS OF OPERATING THE SAME, AND METHODS OF PROCESSING WORKPIECES USING THE SAME

(71) Applicant: ELECTRO SCIENTIFIC INDUSTRIES INCORPORATED, Beaverton, OR (US)

(72) Inventors: Corie NEUFELD, Beaverton, OR (US); Mark KOSMOWSKI, Beaverton, OR (US); Mark UNRATH, Beaverton, OR (US)

(73) Assignee: ELECTRO SCIENTIFIC INDUSTRIES INCORPORATED, Beaverton, OR (US)

(21) Appl. No.: 18/547,807

(22) PCT Filed: Feb. 14, 2022
(86) PCT No.: PCT/US2022/016320

§ 371 Date: Aug. 24, 2023

Related U.S. Application Data
(60) Provisional application No. 63/157,229, filed on Mar. 5, 2021.

(51) Int. Cl. B23K 26/062; B23K 26/08

(52) U.S. Cl. CPC B23K 26/062; B23K 26/08

(57) ABSTRACT

Numerous embodiments are disclosed. In one, a laser-processing apparatus includes a workpiece handling system having an unwind assembly including an unwind spindle operative to support an unwind material roll of a workpiece, and a rewind assembly including a rewind spindle operative to support a rewind material roll of the workpiece and receive the workpiece from the laser-processing apparatus. In another, a laser-processing apparatus includes a workpiece handling system having a web handling assembly attached to an upper structure configured to support an unwind spindle supporting a unwind material roll of a workpiece, wherein the web handling assembly is positioned within a space above the fixture. The laser-processing apparatus further includes a web tensioner assembly configured to apply a biasing force on the tensioning roller to maintain the workpiece in a desired state of tension.

### CROSS-REFERENCE TO RELATED APPLICATIONS

This application is a national phase application of PCT/US2022/016320 filed Feb. 14, 2022 which claims the benefit of U.S. Provisional Application No. 63/157,229, filed Mar. 5, 2021, the contents of which are incorporated by reference in their entirety.

### TECHNICAL FIELD

Embodiments discussed herein relate generally to apparatuses for laser-processing workpieces and, more particularly, to a laser-processing apparatus incorporating various workpiece handling systems, methods of operating the same and methods of laser-processing workpieces using the same.

### BACKGROUND

A system or apparatus for laser-processing relatively thin, flexible workpieces (also known as a “webs”) can sometimes be provided with, or be used in conjunction with, a workpiece handling system adapted to guide the web to the laser-processing apparatus (e.g., so the web can be subjected to laser-processing) and to remove the laser-processed web from the apparatus. However, conventional handling systems (e.g., having multiple idler rollers, turn rollers, and web-tensioning dancer rollers) are known to be bulky and take up valuable manufacturing floor space. Reduction of system footprint by the integration of workpiece handling systems into the structure supporting the laser-processing apparatus can result in disturbance of the laser processing beam position due to the acceleration and deceleration of the web-handling rolls. As such, there is an ongoing need for a compact workpiece handling system whose mass is mechanically decoupled from the support structure of the laser-processing apparatus.

### BRIEF DESCRIPTION OF THE DRAWINGS

FIG. 1 schematically illustrates a laser-processing apparatus according to one embodiment.

FIG. 2 schematically illustrates a workpiece processing system having a first workpiece handling system and a second workpiece handling system, according to one embodiment.

FIG. 3 illustrates a plan view of the embodiment of a workpiece processing system taken along line XI-XI′ as shown in FIG. 2.

FIG. 4 schematically illustrates a workpiece processing system having a workpiece handling system, according to another embodiment.

FIG. 5 schematically illustrates a detailed view of the embodiment of a workpiece processing system shown in FIG. 4.

FIG. 6 schematically illustrates a workpiece processing system having a workpiece handling system, according to another embodiment.

FIG. 7 schematically illustrates a detailed view of the embodiment of a workpiece processing system shown in FIG. 6.

FIGS. 8 and 9 schematically illustrate a workpiece processing system having a first and second handling system shown in a first position and a second position, according to one embodiment.

FIG. 10 schematically illustrates a web handling assembly according to one embodiment.

FIGS. 11-13 schematically illustrate various positional states of a web tensioning apparatus of the embodiment of a workpiece handling system shown in FIGS. 8 and 9.

### SUMMARY

One embodiment of the present invention can be characterized as a system for use in processing a workpiece provided as a web material that includes a laser source operative to generate beam of laser energy, wherein the beam of laser energy is propagatable along a beam path, and a fixture operative to secure the workpiece at a location intersecting with the beam path, wherein the fixture is movable along a first direction and a second direction. A first workpiece handling system may be provided that includes an unwind assembly including an unwind spindle operative to support an unwind material roll of the workpiece, wherein the unwind spindle is operative to supply the workpiece to the laser-processing apparatus, and a rewind assembly including a rewind spindle operative to support a rewind material roll of the workpiece, wherein the rewind spindle is operative to receive the workpiece from the laser-processing apparatus. The system may further include a first shuttle assembly comprising a first movable frame mounted on a first shuttle support and configured to support the unwind assembly and the rewind assembly, wherein the first movable frame is movable in the first direction or the second direction that the fixture is movable. The system may further include a second workpiece handling system including a return spindle operative to receive the workpiece from the laser-processing apparatus and return the workpiece to the laser-processing apparatus, and a second shuttle assembly comprising a second movable frame mounted on a second shuttle support and configured to support the return spindle, wherein the second movable frame is movable in the first direction or the second direction that the fixture is movable.

Another embodiment of the present invention can be characterized as a system for use in processing a workpiece provided as a web material, that includes a laser-processing apparatus including a laser source operative to generate a beam of laser energy, wherein the beam of laser energy is propagatable along a beam path. The system may further include a fixture operative to secure the workpiece at a location intersecting with the beam path, wherein the fixture is movable along a first direction and a second direction. The system may further include a workpiece handling system having an unwind assembly including an unwind spindle operative to support an unwind material roll of the workpiece. The unwind spindle may be operative to supply the workpiece to the laser-processing apparatus. The system may further include a rewind assembly including a rewind spindle operative to support a rewind material roll of the workpiece, wherein the rewind spindle is operative to receive the workpiece from the laser-processing apparatus, and a shuttle assembly comprising a movable frame mounted on a shuttle support and configured to support the unwind assembly and the rewind assembly. The movable frame may be movable along the first direction or the second direction. The system further include a workpiece return assembly mounted to the fixture, and configured to receive the workpiece from the laser-processing apparatus and direct the workpiece to the laser-processing apparatus.

Another embodiment of the present invention can be characterized as a system for use in processing a workpiece provided as a web material, that includes a laser-processing apparatus having a laser source operative to generate a beam of laser energy, wherein the beam of laser energy is propagatable along a beam path, and a fixture operative to secure the workpiece at a location intersecting with the beam path, wherein the fixture is movable. The system may further include a first workpiece handling system configured to supply the workpiece to the laser-processing apparatus, wherein the workpiece handling system includes a first web handling assembly attached to an upper structure configured to support an unwind spindle configured to support a unwind material roll of the workpiece, wherein the first web handling assembly is positioned within a space above the fixture, and a web tensioner assembly including a tensioning roller secured to the fixture by a biasing mechanism configured to apply a biasing force on the tensioning roller to maintain the workpiece in a desired state of tension.

The system for processing a workpiece provided as a web material may further include a second workpiece handling system operative to receive the workpiece from the laser-processing apparatus, wherein the second workpiece handling system includes a second web handling assembly attached to an upper structure configured to support a rewind spindle configured to support a rewind material roll made of the workpiece, wherein the second web handling assembly is positioned within a space above the fixture. The system may further include a web tensioner assembly having a tensioning roller secured to the fixture by a biasing mechanism configured to apply a biasing force on the web material to maintain the workpiece in a desired state of tension.

Another embodiment of the present invention can be characterized as a system for use in processing a workpiece provided as a web material that includes: a laser-processing apparatus having a laser source operative to generate a beam of laser energy, wherein the beam of laser energy is propagatable along a beam path; and a fixture operative to secure the workpiece at a location intersecting with the beam path, wherein the fixture is movable along a first direction and a second direction. The system may further include a first workpiece handling system including an unwind assembly having an unwind spindle operative to support an unwind material roll of the workpiece, and a web biasing system, wherein the unwind spindle is operative to supply the workpiece to the laser-processing apparatus. The web biasing system is operative to apply a biasing force to the web material to maintain the web material in a desired state of tension. The system may further include a rewind assembly including a rewind spindle operative to support a rewind material roll of the workpiece, wherein the rewind spindle is operative to receive the workpiece from the laser-processing apparatus, and a first shuttle assembly comprising a first movable frame mounted on a first shuttle support and configured to support the unwind assembly and the rewind assembly, wherein the first movable frame is movable in the first direction or the second direction that the fixture is movable. A second workpiece handling system may be provided that includes a return spindle operative to receive the workpiece from the laser-processing apparatus and return the workpiece to the laser-processing apparatus, and a second shuttle assembly comprising a second movable frame mounted on a second shuttle support and configured to support the return spindle, wherein the second movable frame is movable in the first direction or the second direction that the fixture is movable.

### DETAILED DESCRIPTION

Example embodiments are described herein with reference to the accompanying drawings. Unless otherwise expressly stated, in the drawings the sizes, positions, etc., of components, features, elements, etc., as well as any distances therebetween, are not necessarily to scale, but are exaggerated for clarity. In the drawings, like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

The terminology used herein is for the purpose of describing particular example embodiments only and is not intended to be limiting. Unless otherwise defined, all terms (including technical and scientific terms) used herein have the same meaning as commonly understood by one of ordinary skill in the art. As used herein, the singular forms “a,” “an” and “the” are intended to include the plural forms as well, unless the context clearly indicates otherwise. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one node could be termed a “first node” and similarly, another node could be termed a “second node”, or vice versa.

Unless indicated otherwise, the term “about,” “thereabout,” etc., means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Spatially relative terms, such as “below,” “beneath,” “lower,” “above,” and “upper,” and the like, may be used herein for ease of description to describe one element or feature's relationship to another element or feature, as illustrated in the FIGS. It should be recognized that the spatially relative terms are intended to encompass different orientations in addition to the orientation depicted in the FIGS. For example, if an object in the FIGS. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly.

The section headings used herein are for organizational purposes only and, unless explicitly stated otherwise, are not to be construed as limiting the subject matter described. It will be appreciated that many different forms, embodiments and combinations are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

### I. SYSTEM—OVERVIEW

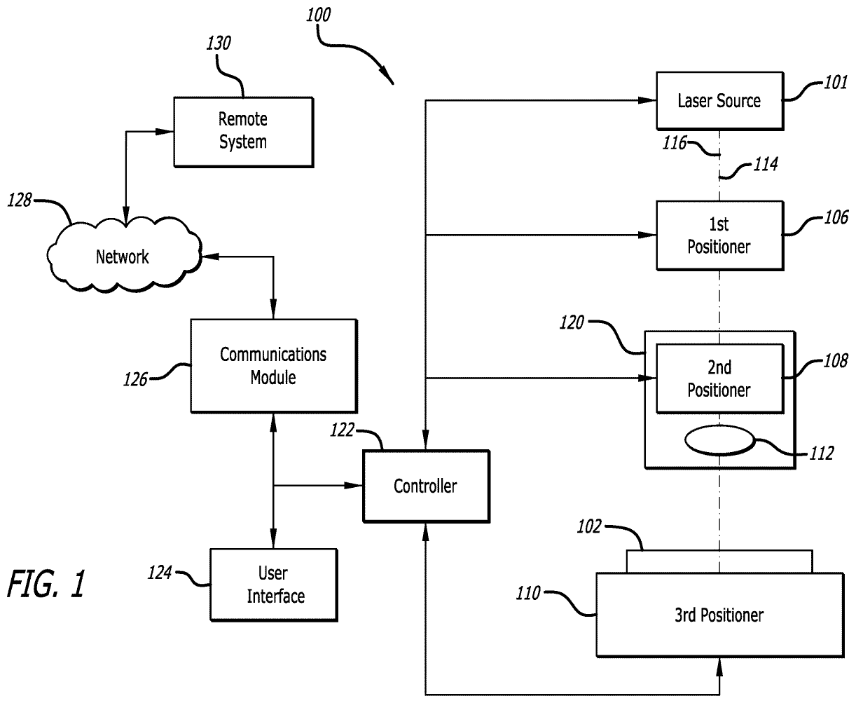

FIG. 1 schematically illustrates a laser-processing apparatus in accordance with one embodiment of the present invention.

Referring to the embodiment shown in FIG. 1, a laser-processing apparatus 100 (also referred to herein simply as an “apparatus”) for processing a workpiece can be characterized as including a laser source 101 for generating a beam of laser energy 116, propagatable along a beam path 114, a first positioner 106, a second positioner 108, a third positioner 110 and a scan lens 112. The scan lens 112 one of the positioners can, optionally, be integrated into a common housing or “scan head” 120. For example, scan lens 112 and the second positioner 108 can be integrated into a common scan head 120. Each of the first positioner 106 and the second positioner 108 is operative to diffract, reflect, refract, or otherwise deflect the beam of laser energy 116 so as to deflect a beam path 114 along which laser energy in the beam of laser energy 116 travels as it propagates from the laser source 101 to the scan lens 112. The scan lens 112 focuses an incident beam of laser energy, which is ultimately delivered to a workpiece 102. Although FIG. 1 illustrates the laser-processing apparatus 100 as including the first positioner 106 and the second positioner 108, it will be appreciated that one or both of these optical components may be omitted from the laser-processing apparatus 100 if desired. Likewise, the third positioner 110 may be omitted if desired. Although not illustrated, the laser-processing apparatus 100 may include one or more other optical components (also referred to herein as “optics”, such as mirrors, lenses, polarizers, waveplates, apertures, beam expanders, beam shapers, wavefront compensation optics, relay optics, or the like or any combination thereof) arranged in the beam path between the laser source 101 and the scan lens 112.

Generally, the apparatus 100 includes one or more controllers, such as controller 122, to control, or facilitate control of, the operation of the apparatus 100. In one embodiment, the controller 122 is communicatively coupled (e.g., over one or more wired or wireless, serial or parallel, communications links, such as USB, RS-232, Ethernet, Firewire, Wi-Fi, RFID, NFC, Bluetooth, Li-Fi, SERCOS, MARCO, EtherCAT, or the like or any combination thereof) to one or more components of the apparatus 100, such as the laser source 101, the first positioner 106, the second positioner 108, third positioner 110, the scan lens 112 (when provided as a variable-focal length lens), etc., which are thus operative in response to one or more control signals output by the controller 122.

The apparatus 100 may further include a user interface 124 communicatively coupled to the controller 122 (e.g., over one or more wired or wireless, serial or parallel, communications links, such as USB, RS-232, Ethernet, Firewire, Wi-Fi, RFID, NFC, Bluetooth, Li-Fi, SERCOS, MARCO, EtherCAT, or the like or any combination thereof). The user interface 124 can include one or more output devices, one or more input devices, or any combination thereof. Generally, an output device is any device capable of rendering or otherwise conveying information through any human-perceptible stimuli (e.g., visual, audible, tactile, etc.). Examples of output devices include monitor, a printer, a speaker, a haptic actuator, and the like. Generally, an input device is any device that enables, e.g., a user of the apparatus 100, to provide instructions, commands, parameters, information, or the like, to operate the apparatus 100 (or to facilitate operation of the apparatus 100). Examples of input devices include a keyboard, mouse, touchpad, touchscreen, microphone, a camera, and the like.

Optionally, the apparatus 100 includes a communications module 126 communicatively coupled to the controller 122 (e.g., over one or more wired or wireless, serial, or parallel, communications links, such as USB, RS-232, Ethernet, Firewire, Wi-Fi, RFID, NFC, Bluetooth, Li-Fi, SERCOS, MARCO, EtherCAT, or the like or any combination thereof). The communications module 126 is operative to transmit data, receive data, or a combination thereof. Accordingly, the communications module 126 can include circuitry, antennas, connectors, or the like or any combination thereof, to transmit and/or receive data through a wired or wireless link to another device or network (e.g., network 128). In one example, the communications module 126 can be a connector that operates in conjunction with software or firmware in the controller 122 to function as a serial port (e.g., RS232), a Universal Serial Bus (USB) port, an IR interface or the like or any combination thereof. In another example, the communications module 126 can be a universal interface driver application specific integrated circuit (UIDA) that supports plural different host interface protocols, such as RS-232C, IBM46XX, Keyboard Wedge interface, or the like or any combination thereof. The communications module 126 may include one or more modules, circuits, antennas, connectors, or the like, as known in the art, to support other known communication modes, such as USB, Ethernet, Bluetooth, Wi-Fi, infrared (e.g., IrDa), RFID communication, or the like or any combination thereof. Instead of being a separate component from the controller 122, it will be appreciated that the communications module 126 may be incorporated as part of the controller 122 in any known or suitable manner.

The network 128 may be communicatively coupled (e.g., over one or more wired or wireless, serial, or parallel, communications links, such as USB, RS-232, Ethernet, Firewire, Wi-Fi, RFID, NFC, Bluetooth, Li-Fi, SERCOS, MARCO, EtherCAT, or the like or any combination thereof) to one or more systems remote to the apparatus 100 (e.g., remote system 130, as identified in FIG. 1). In one embodiment, the remote system 130 may be a device such as a computer (e.g., a desktop computer, a laptop computer, a tablet computer, a smartphone, etc.), a computing system (e.g., a cloud computing platform), another controller or communications module (e.g., associated with another apparatus such as apparatus 100), or the like or any combination thereof. The remote system 130 can be a device owned or otherwise operated by a user of the apparatus 100, by a manufacturer of the apparatus 100, by a technician responsible for performing maintenance on the apparatus 100, or the like or any combination thereof. Through the communications module 126 and network 128, the controller 122 may communicate various data to the remote system 130. Examples of data that can thus be output to the remote system 130 include the aforementioned image data, or measurement data or notification data (both discussed in greater detail below), or the like or any combination thereof. Data output by the remote system 130 may be input to the controller 122 (e.g., via the network 128 and communications module 126) and represent instructions, commands, parameters, information, or the like, to operate the apparatus 100 or to otherwise influence or facilitate any operation of the apparatus 100.

### II. EXAMPLE EMBODIMENTS CONCERNING WORKPIECE HANDLING SYSTEMS

Although not illustrated in FIG. 1, a workpiece handling system may be provided. Generally, the workpiece handling system can be configured to load a workpiece 102 to be processed, to unload the workpiece 102 once it has been processed, or a combination thereof. In embodiments in which the workpiece 102 is a relatively-thin, flexible object (also known as a “web,” which may include fabric, paper, foil, laminate, an FPC panel, an FPC, or the like or any combination thereof), the workpiece handling system may be provided as a roll-to-roll system configured to guide the workpiece 102 (e.g., drawn from a spool or roll) to the apparatus 100 for processing and remove the processed workpiece 102 from the apparatus 100 (e.g., by loading the processed workpiece 102 onto another spool or roll). What follows are various exemplary embodiments of such workpiece handling systems.

A. Workpiece Handling Systems with Separately-Supported Rollers

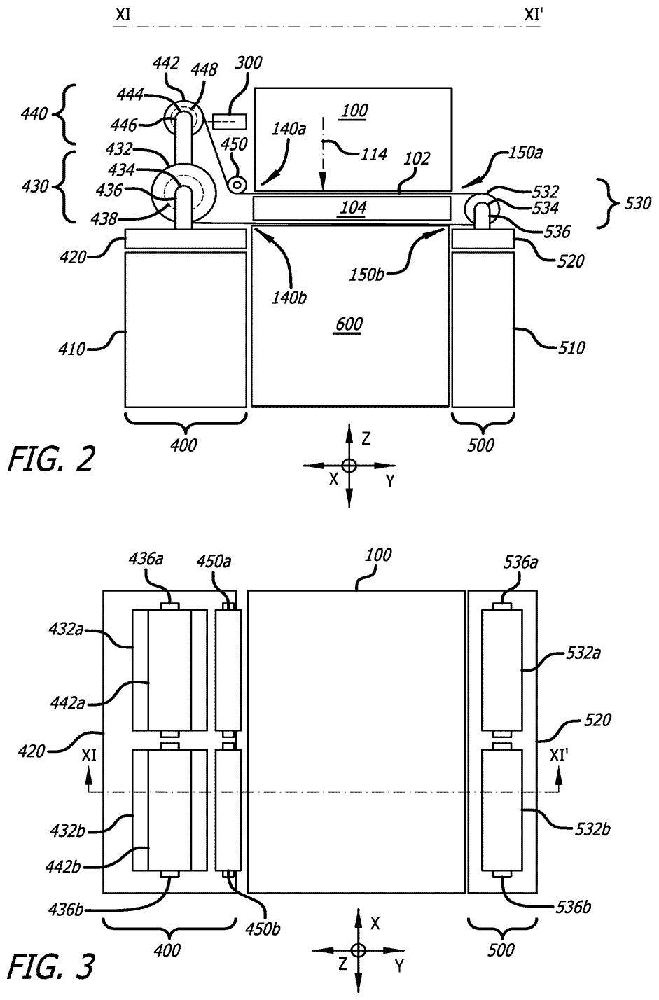

Referring to FIGS. 2 and 3, a first workpiece handling system configured to handle a web, such as workpiece handling system 400, may be configured to guide the workpiece 102 (e.g., drawn from an unwind material roll 442 formed of the workpiece 102) to the apparatus 100 onto a fixture 104 (e.g., through a first port 140a of the apparatus 100) for processing. In this embodiment, the apparatus 100 and the fixture 104 are mounted on a base 600, separately from the first workpiece handling system 400 and the second workpiece handling system 500. The workpiece handling system 400 may also be configured to remove the processed workpiece 102 from the fixture 104 (e.g., through a second port 140b of the apparatus 100 onto a rewind material roll 432 formed of the workpiece 102). A second workpiece handling system may be provided, such as workpiece handling system 500, that is configured to receive the workpiece 102 from the fixture 104 (e.g., through a third port 150a of the apparatus 100) and return it to the workpiece handling system 400 (e.g., through a fourth port 150b of the apparatus 100).

In the illustrated embodiment, the fixture 104 is coupled to a stage of the third positioner 110 of the apparatus 100. As such, the fixture 104 is operative to secure the workpiece 102 at a location intersecting with the beam path 114. In this case, the third positioner 110 is provided as a split-stage positioning system as discussed above, and the stage that carries the fixture 104 is a Y-stage. Accordingly, the fixture 104 is movable along the Y-direction, and one or more components such as the second positioner 108, scan lens 112, or the like or any combination thereof, is movable over the fixture 104 along the X-direction (e.g., by a linear stage which, in turn, is mounted on a frame, gantry, etc.). In another embodiment, the fixture 104 may be movable along the X direction. As mentioned above, the fixture 104 is operative to apply a force (e.g., a mechanical force, an electrostatic force, a vacuum force, a magnetic force, etc.) to the workpiece 102 to fix, hold, or otherwise secure the workpiece 102 thereto (e.g., during processing of the workpiece 102). Accordingly, the fixture 104 may be provided as a vacuum chuck, an electrostatic chuck, a magnetic chuck, etc., as is known in the art.

As shown in FIG. 2, the first workpiece handling system 400 may include an unwind assembly 440 having an unwind material roll 442 formed of the workpiece 102 mounted on an unwind spindle 444 supported by a support mechanism 446 and operative to supply the workpiece 102 to the fixture 104 (e.g., through the first port 140a). The unwind assembly 440 may include a web biasing system 300 positioned proximate to a location where the web material separates from the unwind material roll 442. The web biasing system 300 may be configured to apply a biasing force on the web material proximate to the location where the web material separates from the unwind material roll 442 in order to maintain the workpiece 102 in a desired state of tension as it separates from the unwind material roll 442. In one embodiment, the web biasing system 300 comprises a non-contact biasing system such as an air bar configured to emit streams of air incident on the web material. In another embodiment, the web biasing system 300 comprises a contact roller (not shown) configured to apply a force on the web material as it unwinds from the unwind material roll 442. A turn roller 450 configured to guide the workpiece 102 into the first port 140a may be provided. In one embodiment, the turn roller 450 may be provided as a cylindrical element mounted on a rotating spindle. In another embodiment, the turn roller 450 may be provided as an air turn assembly. As is known in the art, an “air turn” is a cylindrical element with either a slotted, perforated, or porous surface configured to generate a cushion of pressurized air between the workpiece 102 and the cylinder. The turn roller 450 may also include a biasing or tensioning device (not shown) configured to apply a force on the web material in order to maintain the workpiece 102 in a desired state of tension. In some embodiments, the unwind assembly 440 may also include one or more balancing spindles 448 positioned coaxially with the unwind spindle 444 (e.g., inside the unwind material roll 442). The balancing spindle 448 may be configured to rotate in the opposite direction relative to the unwind spindle 444, in order to counteract, cancel or damp out any forces due to the acceleration or deceleration of the unwind spindle 444 and the unwind material roll 442.

The first workpiece handling system 400 may further include a rewind assembly 430 having a rewind material roll 432 formed of the workpiece 102 mounted on a rewind spindle 434 supported by a support mechanism 436. The rewind assembly 430 is configured to receive the workpiece 102 from the return assembly 530 (described below), from the second port 140b. In some embodiments, the rewind assembly 430 may also include balancing spindle 438 positioned coaxially with the rewind spindle 434 (e.g., inside the rewind material roll 432). The balancing spindle 438 may be configured to rotate in the opposite direction relative to the rewind spindle 434, in order to counteract, cancel or damp out any forces due to the acceleration or deceleration of the rewind spindle 434 and the rewind material roll 432. In some embodiments, the support mechanism 436 may include a biasing mechanism configured to move the rewind spindle 434 in the Y-direction (e.g., to maintain the workpiece 102 in a desired state of tension).

The unwind assembly 440 and the rewind assembly 430 may be supported by a first shuttle assembly 420 comprising a first movable frame mounted on a first shuttle support 410. In one embodiment, the first shuttle assembly 420 may be provided as a linear motion stage configured to move the unwind assembly 440 and the rewind assembly 430 in at least one direction, thereby moving the workpiece 102 relative to the fixture 104. As such, the first movable frame is movable in the X-direction. In the illustrated embodiment, the first shuttle assembly 420 moves the unwind assembly 440 and the rewind assembly 430 in the X-direction, (orthogonal to the Y- and Z-directions) to adjust or maintain a desired position of the workpiece 102. Provided as such, the first shuttle support 410 is configured to be mounted to the factory floor separately from the base 600 that supports the laser-processing apparatus 100. This arrangement means that the only forces applied to the laser-processing apparatus 100 by the first workpiece handling system 400 are through the web material of the workpiece 102. Provided as such, reaction forces due to the acceleration and deceleration of the shuttle assembly 420 that may disturb the laser-processing apparatus 100 may be minimized. In some embodiments, the first shuttle assembly 420 may move the unwind assembly 440 and the rewind assembly 430 in the Y-direction (e.g., to work in concert with the web biasing system 300 and the turn roller 450 to maintain the workpiece 102 in a desired state of tension). As such, the first movable frame is also movable in the Y-direction (the direction the fixture 104 is movable).

In the illustrated embodiment, the second workpiece handling system 500 may include a workpiece return assembly 530 comprising a return roll 532 supported by a return spindle 534 mounted on a support/biasing mechanism 536 attached to a second shuttle assembly 520. The return roll spindle 534 may be operative to receive the workpiece 102 from fixture 104 of the apparatus 100 (e.g., from the third port 150a) and return the workpiece 102 to the apparatus 100 (e.g., through the fourth port 150b). The second shuttle assembly 520 may include a second movable frame mounted on a second shuttle support 510. In one embodiment, the second shuttle assembly 520 may be provided as a linear motion stage configured to move the workpiece return assembly 530 in at least one direction, thereby moving the workpiece 102 relative to the fixture 104. In the illustrated embodiment, the second shuttle assembly 520 moves the workpiece return assembly 530 in the X-direction, (orthogonal to the Y- and Z-directions) to adjust or maintain a desired position of the workpiece 102. As such, the second movable frame is movable in the X-direction. Provided as such, the second shuttle support 510 is configured to be mounted to the factory floor separately from the base 600 that supports the laser-processing apparatus 100. This arrangement means that the only forces applied to the laser-processing apparatus 100 by the second workpiece handling system 500 are through the web material of the workpiece 102. Provided as such, reaction forces due to the acceleration and deceleration of the shuttle assembly 520 that may disturb the laser-processing apparatus 100 may be minimized. In some embodiments, the second shuttle assembly 520 may move the workpiece return assembly 530 in the Y-direction (e.g., to work in concert with the first workpiece handling system 400 to maintain the workpiece 102 in a desired state of tension). As such, the second movable frame is also movable in the Y-direction (the direction the fixture 104 is movable).

Referring still to FIG. 2, each of the unwind material roll 442 and the rewind material roll 432 may include a distance sensor (not shown) (e.g., mounted to the unwind spindle 444, rewind spindle 434, the support/biasing mechanisms 446 and 436, or the shuttle assembly 420, or beneath the rewind material roll 432) configured to measure a distance to a portion of the workpiece 102 fed under an associated roll 442/432 and generate sensor data representative of the distance measured. The sensor data can be output from the distance sensor (e.g., as one or more sensor signals) to a controller (e.g., the handler controller) where it is used to control the manner with which the unwind spindles 444 and 434 are rotated (e.g., in terms of direction, speed, amount, or the like or any combination thereof).

Although not shown, the workpiece handling systems 400 and 500 may also include one or more controllers (collectively and generically referred to herein as a “handling controller”) to control, or facilitate control of, the operation of the workpiece handling systems 400 and 500. In one embodiment, the handling controller is communicatively coupled (e.g., over one or more wired or wireless, serial or parallel, communications links, such as USB, RS-232, Ethernet, Firewire, Wi-Fi, RFID, NFC, Bluetooth, Li-Fi, SERCOS, MARCO, EtherCAT, or the like or any combination thereof) to one or more of the aforementioned components of the workpiece handling system (e.g., any motor or actuator coupled to the unwind spindle 444, the rewind spindle 434, the return spindle 534, etc.), which are thus operative in response to one or more control signals outputted by the handler controller.

Generally, the handler controller includes one or more processors operative to generate the aforementioned control signals upon executing instructions. A processor can be provided as a programmable processor (e.g., including one or more general purpose computer processors, microprocessors, digital signal processors, or the like or any combination thereof) operative to execute the instructions. Instructions executable by the processor(s) may be implemented software, firmware, etc., or in any suitable form of circuitry including programmable logic devices (PLDs), field-programmable gate arrays (FPGAs), field-programmable object arrays (FPGAs), application-specific integrated circuits (ASICs)— including digital, analog and mixed analog/digital circuitry—or the like, or any combination thereof. Execution of instructions can be performed on one processor, distributed among processors, made parallel across processors within a device or across a network of devices, or the like or any combination thereof.

In one embodiment, the handler controller includes tangible media such as computer memory, which is accessible (e.g., via one or more wired or wireless communications links) by the processor. As used herein, “computer memory” includes magnetic media (e.g., magnetic tape, hard disk drive, etc.), optical discs, volatile or non-volatile semiconductor memory (e.g., RAM, ROM, NAND-type flash memory, NOR-type flash memory, SONOS memory, etc.), etc., and may be accessed locally, remotely (e.g., across a network), or a combination thereof. Generally, the instructions may be stored as computer software (e.g., executable code, files, instructions, etc., library files, etc.), which can be readily authored by artisans, from the descriptions provided herein, e.g., written in C, C++, Visual Basic, Java, Python, Tel, Perl, Scheme, Ruby, assembly language, hardware description language (e.g., VHDL, VERILOG, etc.), etc. Computer software is commonly stored in one or more data structures conveyed by computer memory.

In the illustrated embodiment, the workpiece 102 is unwound from the unwind material roll 442 and is subsequently fed under the turn roller 450 and onto the fixture 104 (e.g., through the first port 140a, so that a portion of the workpiece 102 over the fixture 104 can be processed by the apparatus 100). From the fixture 104, the workpiece 102 is guided through the third port 150a to be fed over the return roll 532, and is subsequently fed back under the return roll 532, and below the fixture 104 (e.g., through the fourth port 150b) and exiting the second port 140b before it is ultimately wound onto the rewind spindle 434 (e.g., thereby forming the rewind material roll 802b). Initially, the workpiece 102 is manually fed over and under the various aforementioned rollers (e.g., from the unwind spindle 444, over the fixture 104, around the return roll 532, under the fixture 104 and onto the rewind spindle 434, as discussed above) so as to be installed into the workpiece handling systems 400 and 500.

Each of the unwind spindle 444 and rewind spindle 434 is coupled to, and driven (i.e., rotated) by one or more motors or other actuators (not shown). The return spindle 534 may also be coupled to, and driven by one or more motors or other actuators. Thus, after initial installation, the workpiece 102 can be indexed or otherwise moved over fixture 104 by rotating the unwind spindle 444 and rewind spindle 434 in a coordinated manner. For example, as illustrated in FIG. 2, the workpiece 102 can be moved to the right by rotating the unwind spindle 444 in a clockwise direction and the rewind spindle 434 in a counter-clockwise direction. Likewise, the workpiece 102 can be moved to the left by rotating the unwind spindle 444 in a counter-clockwise direction and the rewind spindle 434 in a clockwise direction.

Constructed as exemplarily described above, an operation of the workpiece handling systems 400 and 500 will now be described. Prior to being processed by the apparatus 100, the workpiece 102 is installed into the workpiece handling systems 400 and 500 (e.g., as discussed above). Next, the unwind spindle 444 and the rewind spindle 434 may be driven (e.g., rotated in a clockwise direction) so as to advance a portion of the workpiece 102 to be processed over the fixture 104. The portion of the workpiece 102 that is positioned over the fixture 104 is also referred to herein as a “loaded portion of the workpiece 102.” As the workpiece 102 is being advanced, sensor signals output by the distance sensors of one or each of the rolls 442/432 are used (e.g., at the handler controller) to control how the unwind spindle 444 and the rewind spindle 434 are rotated. For example, if the sensor signal indicates that the distance between the distance sensor and the workpiece 102 fed under an associated material roll 442/432 is less than a predetermined threshold distance range, then the handler controller can control an operation of a motor or actuator to decrease the rate at which a spindle (e.g., the unwind spindle 444) is rotated. If the sensor signal indicates that the distance between the distance sensor and the workpiece 102 fed under an associated material roll 442/432 is greater than the predetermined threshold distance range, then the handler controller can control an operation of a motor or actuator to increase the rate at which a spindle (e.g., the unwind spindle 444) is rotated. Upon decreasing or increasing the rate at which a spindle is rotated, the distance between the distance sensor and a portion of the workpiece 102 being fed under an associated material roll 442/432 can be maintained to be within the predetermined threshold distance.

After a desired portion of the workpiece 102 is advanced over the fixture 104, the fixture 104 is operated (e.g., in response to a control signal output by the controller 122) to apply a force (e.g., a mechanical force, an electrostatic force, a vacuum force, a magnetic force, etc.) to the loaded portion of the workpiece 102 to fix, hold, or otherwise secure the loaded portion of the workpiece 102 thereto. During processing of the loaded portion of the workpiece 102 by the apparatus 100, the fixture 104 can be moved back and forth along the Y-axis (e.g., due to movement of the Y-stage of the apparatus 100). Once secured to the fixture 104, the loaded portion of the workpiece 102 can likewise be moved along the Y-axis. Generally, movement of the Y-stage supporting the fixture 104 (and, thus, movement of the workpiece 102) along the Y-axis can be characterized by an acceleration that is significantly greater than the angular acceleration of the unwind spindle 444 and/or the rewind spindle 434.

To eliminate or otherwise reduce flutter, wrinkles, or breaks in the workpiece 102 caused by differences in acceleration capabilities between the Y-stage supporting the fixture 104 and the spindles 444 and 434, the web biasing system 300, the turn roller 450, the biasing mechanisms 446 and 448, and elements of the workpiece return assembly 530 may be driven so as to be moved (e.g., along the Z-axis) in a coordinated manner with movement of the fixture 104 along the Y-axis. For example, if the Y-stage supporting the fixture 104 moves to the left along the Y-axis at a velocity, “v,” across a distance “d,” then the biasing mechanisms 446 and/or 448 may apply a force to (and move) the spindles 444, and 434 upward in the Z-direction at some fraction of the velocity and distance (e.g., at a velocity v/2, across a distance d/2). In addition, the turn roller 450 may move in the −Y-direction a distance required in order to maintain the workpiece 102 in a desired state of tension. The web biasing system 300 may also be operated to a greater or lesser degree to modulate the force applied to the web material (e.g., in coordination with the other parts of the system) in order to maintain the workpiece 102 in a desired state of tension. Likewise, if the Y-stage supporting the fixture 104 moves to the right along the Y-axis at a velocity, “v,” across a distance “d,” then the biasing mechanisms 446 and 448 may apply a force (and move) downward along the Z-axis at the appropriate fraction of the velocity and distance (e.g., at a velocity v/2, across a distance d/2). In addition, the turn roller 450 may move in the +Y-direction a distance required in order to maintain the workpiece 102 in a desired state of tension. Generally, the biasing mechanisms 446 and 448 (and thereby the spindles 434 and 444) and/or the turn roller 450 are driven at an acceleration that is closely matched to the acceleration at which the Y-stage is driven. By changing the position of the unwind material roll 442 and/or the rewind material roll 432 and/or the turn roller 450 as described above, a portion of the workpiece 102 between the unwind material roll 442 and the turn roller 450 (as well as a portion of the workpiece 102 between the rewind material roll 432) and the apparatus 100 can remain stationary (or at least substantially stationary) even when the loaded portion of the workpiece 102 is moved along the Y-axis by the fixture 104. Elements of the workpiece return assembly 530 may also be engaged to maintain portions of the workpiece 102 stationary, by operating the support/biasing mechanism 536 and/or the second shuttle assembly 520 to dynamically position the rewind roller 532.

To facilitate coordinated movement of the spindles 434 and 444, the turn roller 450, the return roll 532, and the Y-stage supporting the fixture 104, the apparatus 100 may include an encoder (not shown) operatively coupled to the Y-stage and configured to generate an encoder signal representing data (also referred to herein as “encoder data”) such as the position of the Y-stage, direction in which the Y-stage is traveling, velocity at which the Y-stage is traveling, or the like or any combination thereof, as is known in the art. The encoder may be communicatively coupled (e.g., over one or more wired or wireless, serial, or parallel, communications links) to the handler controller and thus be capable of transmitting encoder data direction to the workpiece handler controller. Alternatively, the encoder may be communicatively coupled (e.g., over one or more wired or wireless, serial, or parallel, communications links) to the controller 122 which, in turn, is communicatively coupled to the handler controller. In this alternative embodiment, the handler controller may receive encoder data from the controller 122 which, in turn, received the encoder data from the encoder. Upon receiving the encoder data, the workpiece handler controller generates and outputs one or more control signals to move the spindles 434 and 444, the turn roller 450, the return roll 532, as discussed above.

Constructed as exemplarily discussed above, the workpiece handling system 400 is adapted to handle a single workpiece 102 (e.g., to guide the workpiece 102 to, and remove the workpiece 102 from, the apparatus 100). In other embodiments, however, a workpiece handling system can be configured to handle multiple workpieces. For example, the workpiece handling systems 400 and 500 can be modified to handle two workpieces. To enable handling of two workpieces, the unwind assembly 440 and the rewind assembly 430 can each include a pair of material rolls and spindles, respectively, as shown in FIG. 3. Referring to FIG. 3, the unwind assembly 440 includes two unwind material rolls (i.e., a first unwind material roll 442a and a second unwind material roll 442b, each generically referred to as the unwind material roll 442″) each mounted to the first shuttle assembly 420 in the same manner as discussed above with respect to FIG. 2 (e.g., by a set of support/biasing mechanisms 446) Likewise, the rewind assembly 430 includes two rewind material rolls (i.e., a first rewind material roll 432a and a second rewind material roll 432b, each generically referred to as the rewind material roll 432″) each mounted to the first shuttle assembly 420 in the same manner as discussed above with respect to FIG. 2. (e.g., by a set of support/biasing mechanisms 436a and 436b). To maintain the workpiece 102 in a desired state of tension as the web unwinds from the unwind material rolls 442a and 442b, the web biasing system 300 may be provided as separate web biasing systems 300a and 300b (not shown) Likewise, the turn roller 450 configured to guide the workpiece 102 to the fixture 104 may be provided as a pair of turn rollers 450a and 450b. In similar fashion, to enable handling of two workpieces, the return assembly 530 can have a pair of return rolls 532a and 532b, each mounted to the second shuttle assembly 520 in the same manner as discussed above with respect to FIG. 2 (e.g., by a set of support/biasing mechanisms 536a and 536b).

B. Workpiece Handling System with a Single Separately-Supported Roller Support

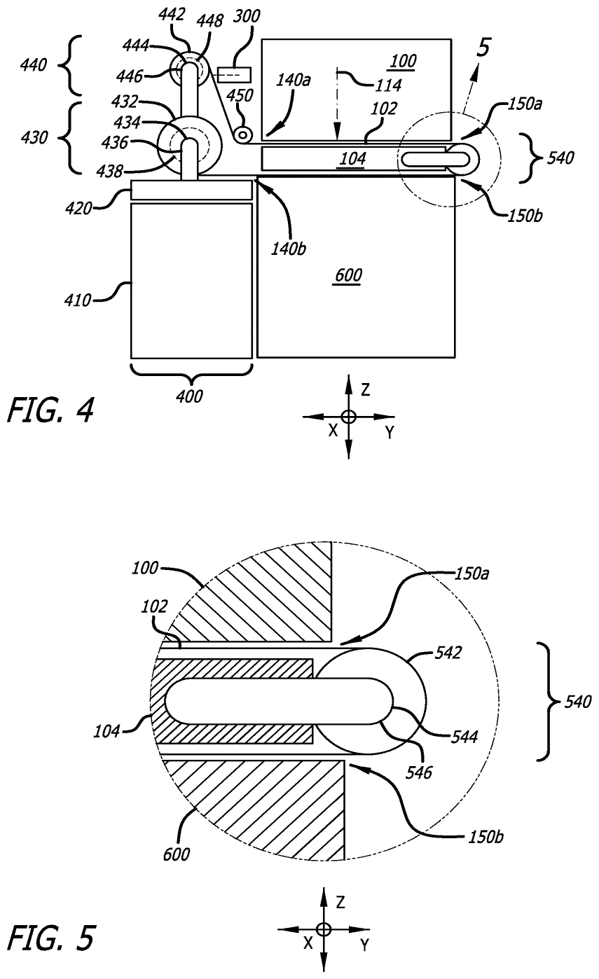

In the embodiments described above, multiple workpiece handling systems are used to position the workpiece 102 relative to the fixture 104 of the apparatus 100. In another embodiment, a single workpiece handling system may be used, in coordination with a dynamic workpiece tensioning system mounted to the fixture 104. FIGS. 4 and 5 illustrate various views of a workpiece handling system configured to handle a web, such as workpiece handling system 400, may be configured to guide the workpiece 102 (e.g., drawn from an unwind material roll 442 formed of the workpiece 102) to the apparatus 100 onto a fixture 104 (e.g., through a first port 140a of the apparatus 100) for processing. In this embodiment, the apparatus 100 and the fixture 104 are mounted on a base 600, separately from the workpiece handling system 400. The workpiece handling system 400 may also be configured to remove the processed workpiece 102 from the fixture 104 (e.g., through a second port 140b of the apparatus 100 onto a rewind material roll 432 formed of the workpiece 102). In contrast to the embodiments described above, the control of returning the workpiece 102 from the fixture 104 to the rewind assembly 430 can be accomplished by a workpiece return assembly 540 mounted to the fixture 104 and operative to receive the workpiece 102 from the fixture 104 of the apparatus 100 (e.g., from the third port 150a). As such, the workpiece return assembly 540 can direct the workpiece 102 back underneath the fixture 104 (e.g., through the fourth port 150b) of the apparatus 100, whereupon the workpiece 102 exits the second port 140b, to be taken up by the rewind assembly 430. FIG. 5 shows a detailed view of the workpiece return assembly 540. The workpiece return assembly 540 may include a return roll 542 mounted on a return spindle 544. The workpiece return assembly 540 may be mounted to the fixture 104 by a support/biasing mechanism 546 configured to apply a biasing force to the workpiece return assembly 540 (e.g., to the return spindle 544) in order to maintain the workpiece 102 in a desired state of tension. The workpiece return assembly 540 may include instrumentation and control components (e.g., encoders and strain gauges) configured to send data representative of the position of the return roll 542 and the load applied by the biasing mechanism 546 to the return spindle 544 to the controller 122 so that the controller 122 can command the fixture 104 and the workpiece return assembly 540 in order to maintain the workpiece 102 in a desired state of tension during processing and movement of the workpiece 102.

In similar fashion to the embodiments described above, the fixture 104 is coupled to a stage of the third positioner 110 of the apparatus 100. As such, the fixture 104 is operative to secure the workpiece 102 at a location intersecting with the beam path 114. In this case, the third positioner 110 is provided as a split-stage positioning system as discussed above, and the stage that carries the fixture 104 is a Y-stage. Accordingly, the fixture 104 is movable along the Y-direction, and one or more components such as the second positioner 108, scan lens 112, or the like or any combination thereof, is movable over the fixture 104 along the X-direction (e.g., by a linear stage which, in turn, is mounted on a frame, gantry, etc.). In another embodiment, the fixture 104 may be movable along the X direction. As mentioned above, the fixture 104 is operative to apply a force (e.g., a mechanical force, an electrostatic force, a vacuum force, a magnetic force, etc.) to the workpiece 102 to fix, hold, or otherwise secure the workpiece 102 thereto (e.g., during processing of the workpiece 102).

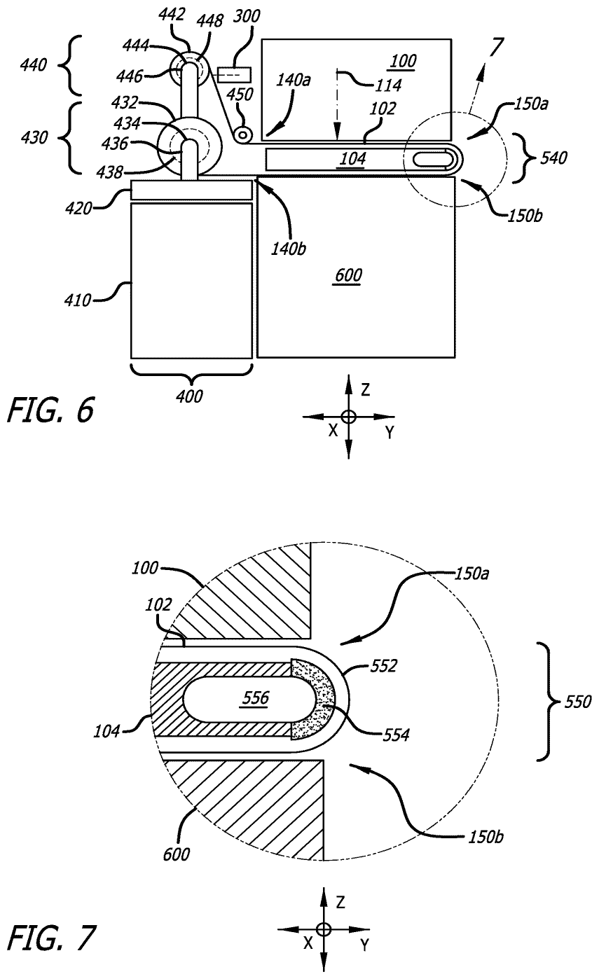

As shown in FIGS. 6 and 7, in another embodiment, the control of returning the workpiece 102 from the fixture 104 to the rewind assembly 430 can be accomplished by a workpiece return assembly 550 mounted to the fixture 104 and operative to receive the workpiece 102 from the fixture 104 of the apparatus 100 (e.g., from the third port 150a). The workpiece 102 is then directed back underneath the fixture 104 (e.g., through the fourth port 150b) of the apparatus 100, whereupon the workpiece 102 exits the second port 140b to be taken up by the rewind assembly 430. FIG. 7 shows a detailed view of the workpiece return assembly 550. The workpiece return assembly 550 may include an air turn surface 552 formed on an air turn substrate 554. The air turn surface 552 and air turn substrate 554 may be formed from a semi-cylindrical element with either a slotted, perforated, or porous surface configured to generate a cushion of pressurized air between the workpiece 102 and the surface (i.e., the air turn surface 552). In one embodiment, the air turn substrate 554 may also include a biasing or tensioning device 556 configured to apply a force to the air turn substrate 554 in order to maintain the workpiece 102 in a desired state of tension. The pressure of the air between the air turn surface 552 and the workpiece 102 may be adjusted in order to maintain the workpiece 102 in a desired state of tension. In similar fashion to the embodiment described above, the workpiece return assembly 550 may include instrumentation and control components (e.g., encoders and strain gauges) configured to send data representative of the load applied by the biasing mechanism 546 to the air turn surface 552 to the controller 122, so that the controller 122 can command the fixture 104 and the workpiece return assembly 550 in order to maintain the workpiece 102 in a desired state of tension during processing and movement of the workpiece 102.

C. Workpiece Handling System with a Shallow-Traversing-Angle Web Support

As described with respect to the embodiments above, high-speed automated processing of flexible printed circuits poses a number of material handling challenges, including the stability of the thin, flexible object (also known as a “web”). Rapid acceleration of the spindles and material rolls while paying out the web to a laser-processing apparatus can result in an unacceptable amount of separation of the web from the material rolls, resulting in damage to the web, causing yield loss and processing downtime. Embodiments of the workpiece handling systems described below can be used to avoid these issues. For example, one method or configuration that enables stable handling of the web is minimizing the traversing angle (i.e., the angle at which the web departs from the material roll) as much as possible. Also, configurations of roll-to-roll material handling systems known in the art can be bulky and consume significant manufacturing floor space. The embodiments described in detail below may be used to maintain a shallow traversing angle of the web while having a small footprint.

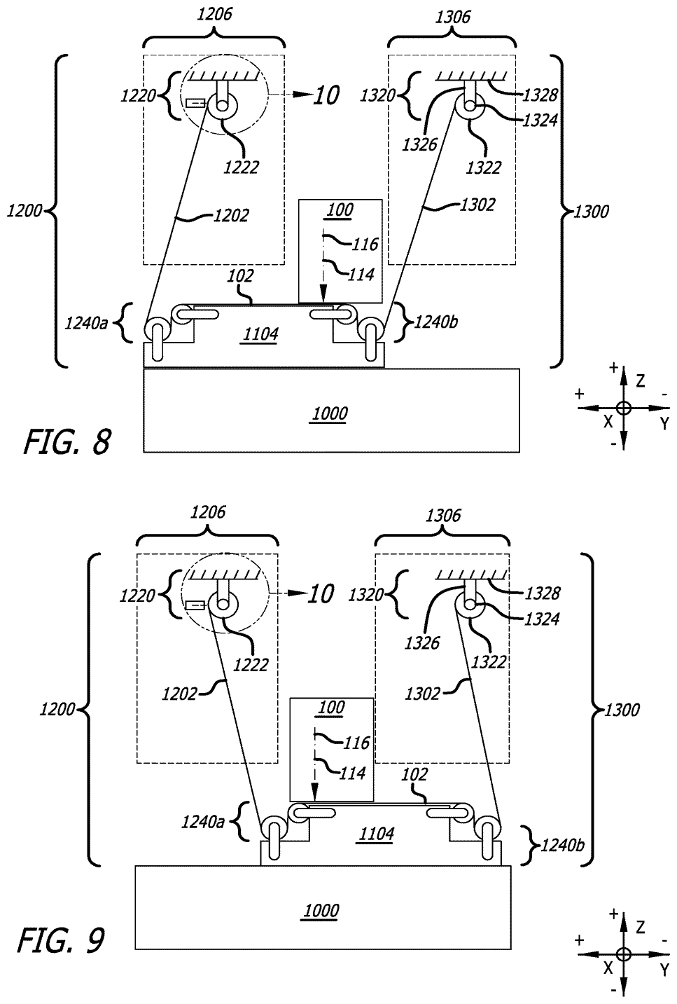

FIGS. 8 and 9 schematically illustrate positional states of an exemplary embodiment of this system. As shown in FIG. 8, a laser-processing apparatus 100 may be provided that is configured to deliver a laser process beam to a workpiece 102 provided as a web material. In one embodiment, a first workpiece handling system 1200 may be provided that is operative to supply the workpiece 102 (e.g., drawn from a first web handling assembly 1220) to the apparatus 100 (i.e., onto a fixture 1104 of the apparatus 100) for processing. The fixture 1104 is operative to secure the workpiece 102 at a location intersecting with the beam path 114 of the beam of laser energy 116 emitted by the laser source 101. The apparatus 100 is mounted to a base 1000 and the fixture 1104 is movably positioned on the base 1000 and configured to position the workpiece 102 relative to the apparatus 100. As mentioned above, the fixture 1104 is operative to apply a force (e.g., a mechanical force, an electrostatic force, a vacuum force, a magnetic force, etc.) to the workpiece 102 to fix, hold, or otherwise secure the workpiece 102 thereto (e.g., during processing of the workpiece 102). Accordingly, the fixture 1104 may be provided as a vacuum chuck, an electrostatic chuck, a magnetic chuck, etc., as is known in the art. FIG. 8 shows the fixture 1104 in the far left-hand position with respect to the apparatus 100 and the base 1000. FIG. 9 shows the fixture 1104 in the far right-hand position (e.g., the farthest extent of travel in the Y-direction), with respect to the base 1000 and the apparatus 100.

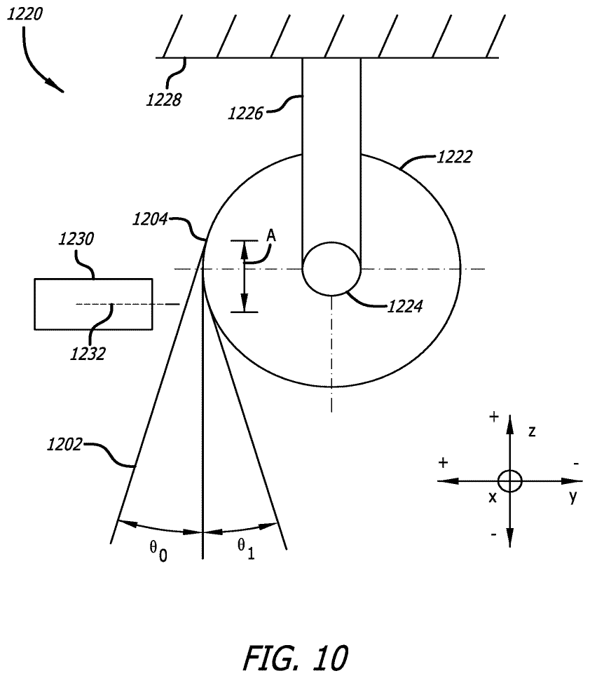

Referring to FIG. 10, in the illustrated embodiment, the first workpiece handling system 1200 may include a first web handling assembly 1220 positioned in a space 1206 located above the fixture 1104. The first web handling assembly 1220 may include a unwind material roll 1222 (e.g., formed of the workpiece 102) mounted on a unwind spindle 1224 that is secured to an upper structure 1228 by a support/biasing mechanism 1226. The support/biasing mechanism 1226 may be configured to apply a force to, (thereby changing the position of), the unwind spindle 1224 (and thereby the position of the unwind material roll 1222). Referring to FIG. 10, the first web handling assembly 1220 may further include web biasing system 1230 configured to apply a biasing force to the web 1202 proximate to the a web contact point 1204 where the web 1202 separates from the unwind material roll 1222. In one embodiment, the web biasing system 1230 comprises a non-contact biasing system such as an air bar configured to emit streams of air 1232 incident on the web material. In another embodiment, the web biasing system 1230 may comprise a contact roller (not shown) configured to apply a force on the web material as it separates from the unwind material roll 1222. During operation, the angle θ of the web (also referred to herein as the “traversing angle θ”) may change from a traversing angle θ₀ oriented counter-clockwise relative to vertical, to traversing angle θ 1 oriented clockwise relative to vertical as the fixture 1104 changes its position in the Y-direction, resulting in a change in the location of the web contact point 1204. As described above, during operation, the traversing angle θ generally should be kept as small as possible, because when the web 1202 unwinds from the unwind material roll 1222 at high speeds or under high accelerations, the web may separate too far from the unwind material roll 1222, resulting in damage to the workpiece 102. During the excursion of the web 1202 from traversing angle θ₀ to θ₁, the web contact point 1204 may change from a position above the unwind spindle 1224 to a position below the unwind spindle 1224, a total distance represented as “A” in FIG. 10. Due to the change in the web contact point 1204, the position of the web biasing system 1230 (or the angle that the stream of air 1232 exits the web biasing system 1230) may be adjustable so that the web biasing system 1230 applies a force to the web 1202 at or near the web contact point 1204 in order to maintain the web material or workpiece 102 in a desired state of tension.

Referring to FIGS. 8, 9 and 11-13, the first workpiece handling system 1200 may further include a web tensioner assembly 1240a configured to maintain the workpiece 102 in a desired state of tension. In one embodiment, the web tensioner assembly 1240a may include a tensioning roller 1242a mounted on a spindle 1244a connected to the fixture 1104 by a support/biasing mechanism 1246a configured to apply a biasing force to (and to adjust the position of) the tensioning roller 1242a in at least the Z-direction relative to the fixture 1104 and the unwind web handling assembly 1220. The web tensioner assembly 1240a may further include an idler roller 1250a configured to position the workpiece 102 at a desired height above the fixture 1104. The support/biasing mechanism 1246a may be operative to position the idler roller 1250a in the Z-direction (e.g., to control the height of the workpiece 102 above the fixture 1104, in the Y-direction (e.g., to work with other components in the first workpiece handling system 1200 in order to maintain the workpiece 102 in a desired state of tension), and in the X-direction (e.g., to make any required adjustments to the position of the idler roller 1250a along the axis of the idler spindle 1252a).

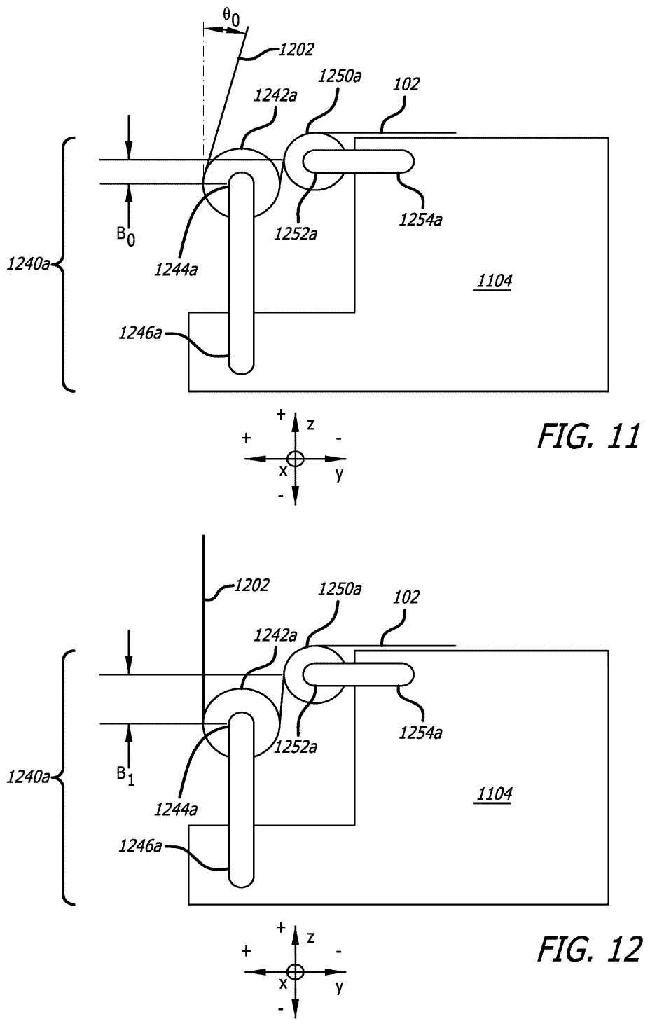

In one embodiment, a second workpiece handling system 1300 may be provided that is operative to receive the workpiece 102 (e.g., originally drawn from the first workpiece handling system 1200) from the apparatus 100 (i.e., from the fixture 1104) after processing. Referring to FIG. 10, in the illustrated embodiment, the second workpiece handling system 1300 may include a second web handling assembly 1320 positioned in a space 1306 located above the fixture 1104. The second web handling assembly 1320 may include a rewind material roll 1322 (e.g., formed of the workpiece 102) mounted on a rewind spindle 1324 that is secured to an upper structure 1328 by a support/biasing mechanism 1326. The support/biasing mechanism 1326 may be configured to apply a force to, (thereby changing the position of), the rewind spindle 1324 (and thereby the position of the rewind material roll 1322). The second workpiece handling system 1300 may also include a web tensioner assembly 1240b configured to maintain the workpiece 102 in a desired state of tension as it with drawn away from the fixture 1104 and directed to the rewind material roll 1322 of the second web handling assembly 1320. In this embodiment, the structure of the web tensioner assembly 1240b is identical to that of the web tensioner assembly 1240a, though arranged in a mirror-image configuration relative to the web tensioner assembly 1240a. In the interest of conciseness, the details of the web tensioner assembly 1240b are not shown in FIGS. 11-13.

Constructed as exemplarily described above, an operation of the workpiece handling systems 1200 and 1300 will now be described. Prior to being processed by the apparatus 100, the workpiece 102 is installed into the workpiece handling systems 1200 and 1300. Next, the unwind spindle 1224 may be driven (e.g., rotated in a counter-clockwise direction) and the rewind spindle 1324 may be driven (e.g., rotated in a clockwise direction) so as to advance a portion of the workpiece 102 to be processed over the fixture 1104. The portion of the workpiece 102 that is positioned over the fixture 104 is also referred to herein as a “loaded portion of the workpiece 102.” After a desired portion of the workpiece 102 is advanced over the fixture 104, the fixture 1104 is operated (e.g., in response to a control signal output by the controller 122) to apply a force (e.g., a mechanical force, an electrostatic force, a vacuum force, a magnetic force, etc.) to the loaded portion of the workpiece 102 to fix, hold, or otherwise secure the loaded portion of the workpiece 102 thereto. During processing of the loaded portion of the workpiece 102 by the apparatus 100, the fixture 1104 can be moved back and forth along the Y-axis (e.g., due to movement of the Y-stage of the apparatus 100). Once secured to the fixture 1104, the loaded portion of the workpiece 102 can likewise be moved along the Y-axis.

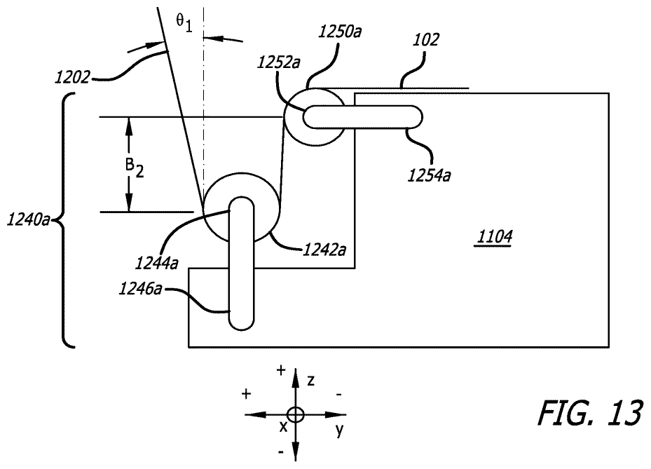

During operation of the laser-processing apparatus 100, as the workpiece 102 is being processed, it is fed from the first web handling assembly 1220, through the web tensioner assembly 1240a, across the fixture 1104 to the second workpiece handling system 1300 where it is fed through the web tensioner assembly 1240b, then taken up by the second web handling assembly 1320 that is positioned in a space 1306 above the fixture 1104 (e.g., onto the rewind material roll 1322). Generally, the biasing mechanisms 1226, 1246a, and 1254a (and thereby the spindles 1224, 1244a, and 1252a) are driven or operated at an acceleration that is closely matched to the acceleration at which the Y-stage (i.e., the fixture 1104) is driven. By changing the position of the tensioning roller 1242a relative to the unwind material roll 1222 and the idler roller 1250a, as described above, a portion of the workpiece 102 between the web contact point 1204 at the unwind material roll 1222 and the point of contact between the workpiece 102 and the idler roller 1250a can remain stationary (or at least substantially stationary) even when the loaded portion of the workpiece 102 is moved along the Y-axis by the fixture 1104. For example, when the fixture 1104 is at the left-hand (e.g., +Y direction) extent of its travel, the web is positioned at an angle θ 0 relative to vertical (and relative to the unwind web handling assembly 1220 and the web tensioner assembly 1240a). In this position, the web contact point 1204 (shown in FIG. 10) is above the unwind spindle 1224. To maintain the workpiece 102 stationary as the fixture 1104 begins to move in the −Y-direction during processing of the workpiece 102, the support/biasing mechanism 1246a is activated to position the spindle 1244a a distance B from the idler roller 1250a. As the fixture 1104 moves to the right, the support/biasing mechanism 1246a applies a biasing force to the web 1202 in order to keep the web stationary. At the point where the web is vertical (e.g., when angle θ=0 as shown in FIGS. 10 and 11), the web contact point 1204 has moved in the −Z-direction (i.e., downward). At this position, in order to keep the portion of the workpiece 102 (e.g., the web 1202) between the web contact point 1204 at the unwind material roll 1222 and the point of contact between the workpiece 102 and the idler roller 1250a stationary, the support/biasing mechanism 1246a applies a biasing force to the spindle 1244a to move the tensioning roller 1242a in the −Z direction to a distance B₁ below the idler roller 1250a. When the fixture 1104 has moved in the −Y-direction to its limit of travel, (to the right, as shown in FIG. 9), the web is positioned at an angle θ₁ relative to vertical (and relative to the unwind web handling assembly 1220 and the web tensioner assembly 1240a). In this position, the web contact point 1204 (shown in FIG. 10) is below the unwind spindle 1224, at a distance A from the where the contact point 1204 was when the web 1202 was oriented at an angle θ₀. At this position, in order to keep the portion of the workpiece 102 between the web contact point 1204 at the unwind material roll 1222 and the point of contact between the workpiece 102 and the idler roller 1250a stationary, the support/biasing mechanism 1246a applies a biasing force to the spindle 1244a to move the tensioning roller 1242a in the −Z direction to a distance B₂ below the idler roller 1250a (as shown in FIG. 13). The configuration of the web tensioner assembly 1240a in this embodiment, allows the distance (from B₀ to B₂) that the spindle 1244a is moved by the support/biasing mechanism 1246a, to be half of the distance A that the web contact point 1204 moves in the Z-direction as the fixture 1104 traverses in the Y-direction.

To facilitate coordinated movement of the tensioning roller 1242a, and the Y-stage supporting the fixture 1104, the apparatus 100 may include an encoder (not shown) operatively coupled to the Y-stage and configured to generate an encoder signal representing data (also referred to herein as “encoder data”) such as the position of the Y-stage, direction in which the Y-stage is traveling, velocity at which the Y-stage is traveling, or the like or any combination thereof, as is known in the art. The encoder may be communicatively coupled (e.g., over one or more wired or wireless, serial, or parallel, communications links) to the handler controller and thus be capable of transmitting encoder data direction to the handler controller. Alternatively, the encoder may be communicatively coupled (e.g., over one or more wired or wireless, serial, or parallel, communications links) to the controller 114 which, in turn, is communicatively coupled to the handler controller. In this alternative embodiment, the handler controller may receive encoder data from the controller 122 which, in turn, received the encoder data from the encoder. Upon receiving the encoder data, the handler controller generates and outputs one or more control signals to move the tensioning roller 1242a as discussed above.

There will inevitably be a delay between the time when encoder signal is output by the encoder and the time when the tensioning roller 1242a is raised or lowered in response to the Y-stage movement. Typically, the delay is on the order of a few milliseconds. The biasing mechanism 1246 of the tensioning roller 1242a, which is constantly exerting a force on the tensioning roller 1242a, thus acts to account for the delay to maintain the workpiece 102 in a desired state of tension until the tensioning roller 1242a are raised or lowered in response to the Y-stage movement. In addition to the encoder data, a strain gauge or other sensor (not shown), may be incorporated into the support/biasing mechanism 1246a and/or the support/biasing mechanism 1254a. The strain gauge may be configured to output data (e.g., representative of the biasing forces applied to the tensioning roller 1242a and the idler roller 1250a) to the controller 122. As described above, in this embodiment, the structure and function of the web tensioner assembly 1240b is identical to that of the web tensioner assembly 1240a, though arranged in a mirror-image configuration relative to the web tensioner assembly 1240a. In the interest of conciseness, the details of the web tensioner assembly 1240b are not shown in FIGS. 11-13.

As processing of the loaded portion of the workpiece 102 is completed (e.g., when the fixture 1104 has reached the left hand end of the support 1000, the processed portion of the workpiece 102 is then taken up by the rewind web handling assembly 1320 (e.g., by a torque motor coupled to the rewind spindle 1324), in coordination with the unwind web handling assembly 1220 paying out another section of the workpiece 102 (e.g., by a torque motor coupled to the unwind spindle 1224). The embodiments and features described above allow for high-speed advancing of the web 1202 to the fixture 1104 without damage to the web 1202 or the workpiece 102.

### III. CONCLUSION

The foregoing is illustrative of embodiments and examples of the invention, and is not to be construed as limiting thereof. Although a few specific embodiments and examples have been described with reference to the drawings, those skilled in the art will readily appreciate that many modifications to the disclosed embodiments and examples, as well as other embodiments, are possible without materially departing from the novel teachings and advantages of the invention. Accordingly, all such modifications are intended to be included within the scope of the invention as defined in the claims. For example, skilled persons will appreciate that the subject matter of any sentence, paragraph, example or embodiment can be combined with subject matter of some or all of the other sentences, paragraphs, examples or embodiments, except where such combinations are mutually exclusive. The scope of the present invention should, therefore, be determined by the following claims, with equivalents of the claims to be included therein.

What is claimed is:

1. A system for use in processing a workpiece provided as a web material, the system comprising:
a laser-processing apparatus including:
a laser source operative to generate a beam of laser energy, wherein the beam of laser energy is propagatable along a beam path;
a fixture operative to secure the workpiece at a location intersecting with the beam path, wherein the fixture is movable along a first direction and a second direction; and
a first workpiece handling system including:
an unwind assembly including an unwind spindle operative to support an unwind material roll of the workpiece, wherein the unwind spindle is operative to supply the workpiece to the laser-processing apparatus;
a rewind assembly including a rewind spindle operative to support a rewind material roll of the workpiece, wherein the rewind spindle is operative to receive the workpiece from the laser-processing apparatus; and
a first shuttle assembly comprising a first movable frame mounted on a first shuttle support and configured to support the unwind assembly and the rewind assembly,
wherein the first movable frame is movable in the first direction or the second direction that the fixture is movable; and
a second workpiece handling system including:
a return spindle operative to receive the workpiece from the laser-processing apparatus and return the workpiece to the laser-processing apparatus; and
a second shuttle assembly comprising a second movable frame mounted on a second shuttle support and configured to support the return spindle, wherein the second movable frame is movable in the first direction or the second direction that the fixture is movable.

2. A system for use in processing a workpiece provided as a web material, the system comprising:
a laser-processing apparatus including:
a laser source operative to generate a beam of laser energy, wherein the beam of laser energy is propagatable along a beam path; and
a fixture operative to secure the workpiece at a location intersecting with the beam path, wherein the fixture is movable along a first direction and a second direction;
a workpiece handling system including:
an unwind assembly including an unwind spindle operative to support an unwind material roll of the workpiece, wherein the unwind spindle is operative to supply the workpiece to the laser-processing apparatus;
a rewind assembly including a rewind spindle operative to support a rewind material roll of the workpiece, wherein the rewind spindle is operative to receive the workpiece from the laser-processing apparatus;
a shuttle assembly comprising a movable frame mounted on a shuttle support and configured to support the unwind assembly and the rewind assembly,
wherein the movable frame is movable along the first direction or the second direction; and
a workpiece return assembly operative to receive the workpiece from the laser-processing apparatus and direct the workpiece to the laser-processing apparatus,
wherein the workpiece return assembly is mounted to the fixture.

3. The system of claim 2, wherein the workpiece return assembly comprises a return spindle.

4. The system of claim 2, further comprising a biasing mechanism mounted to the fixture and configured to apply a biasing force to the workpiece return assembly operative to maintain the workpiece in a desired state of tension.

5. The system of claim 2, wherein the workpiece return assembly comprises an air turn assembly.

6. The system of claim 5, wherein the workpiece return assembly further includes a biasing mechanism mounted to the fixture and configured to apply a biasing force to the air turn assembly operative to maintain the workpiece in a desired state of tension.

7. The system of claim 5, wherein the fixture is configured to apply a biasing force to the workpiece return assembly to maintain the workpiece in a desired state of tension.

8. The system of claim 2, wherein the unwind assembly further includes a web biasing system configured to apply a biasing force to the web material proximate to a location where the web material separates from the unwind material roll.

9. The system of claim 8, wherein the web biasing system comprises a non-contact-biasing system configured to apply a biasing force on the web material proximate to the location where the web material separates from the unwind material roll to maintain the web material in a desired state of tension.

10. The system of claim 8, wherein the web biasing system comprises a contact roller configured to apply a biasing force on the web material proximate to the location where the web material separates from the unwind material roll to maintain the web material in a desired state of tension.

11. The system of claim 9, wherein the non-contact biasing system comprises an air bar configured to emit one or more streams of air incident on the web material proximate to the location where the web material separates from the unwind material roll.

12. The system of claim 8, wherein the web biasing system comprises an air turn assembly configured to apply a biasing force on the web material proximate to the location where the web material separates from the unwind material roll.

13. A system for use in processing a workpiece provided as a web material, the system comprising:
a laser-processing apparatus including:
a laser source operative to generate a beam of laser energy, wherein the beam of laser energy is propagatable along a beam path; and
a fixture operative to secure the workpiece at a location intersecting with the beam path, wherein the fixture is movable; and
a first workpiece handling system operative to supply the workpiece to the laser-processing apparatus, including:
a first web handling assembly attached to an upper structure configured to support an unwind spindle configured to support a unwind material roll of the workpiece,
wherein the first web handling assembly is positioned within a space above the fixture; and
a web tensioner assembly including a tensioning roller secured to the fixture by a biasing mechanism configured to apply a biasing force on the tensioning roller to maintain the workpiece in a desired state of tension.

14. The system of claim 13, further comprising a second workpiece handling system operative to receive the workpiece from the laser-processing apparatus, including:
a second web handling assembly attached to an upper structure configured to support a rewind spindle configured to support a rewind material roll made of the workpiece,
wherein the second web handling assembly is positioned within a space above the fixture; and
a web tensioner assembly including a tensioning roller secured to the fixture by a biasing mechanism configured to apply a biasing force on the web material to maintain the workpiece in a desired state of tension.

15. The system of claim 13, further comprising a web biasing system configured to apply a biasing force to the web material proximate to a location where the web separates from the unwind material roll.

16. A system for use in processing a workpiece provided as a web material, the system comprising:
a laser-processing apparatus including:
a laser source operative to generate a beam of laser energy, wherein the beam of laser energy is propagatable along a beam path; and
a fixture operative to secure the workpiece at a location intersecting with the beam path, wherein the fixture is movable along a first direction and a second direction;
a first workpiece handling system including:
an unwind assembly including an unwind spindle operative to support an unwind material roll of the workpiece, and a web biasing system, wherein the unwind spindle is operative to supply the workpiece to the laser-processing apparatus, and the web biasing system is operative to apply a biasing force to the web material to maintain the web material in a desired state of tension;
a rewind assembly including a rewind spindle operative to support a rewind material roll of the workpiece, wherein the rewind spindle is operative to receive the workpiece from the laser-processing apparatus; and
a first shuttle assembly comprising a first movable frame mounted on a first shuttle support and configured to support the unwind assembly and the rewind assembly,
wherein the first movable frame is movable in the first direction or the second direction that the fixture is movable; and
a second workpiece handling system including:
a return spindle operative to receive the workpiece from the laser-processing apparatus and return the workpiece to the laser-processing apparatus; and
a second shuttle assembly comprising a second movable frame mounted on a second shuttle support and configured to support the return spindle,
wherein the second movable frame is movable in the first direction or the second direction that the fixture is movable.
